(19) United States
(12) Patent Application Publication
(10) Pub. No.: US 2025/0289354 A1
(43) Pub. Date: Sep. 18, 2025

(54) CUSHION WITH ADJUSTABLE SOFTNESS AND HARDNESS AND AUTOMOTIVE SEAT

(71) Applicant: Adient (Chongqing) Automotive Components Co., Ltd., Chongqing (CN)

(72) Inventors: Jun XU, Chongqing (CN); Jie TANG, Chongqing (CN); Shaobin XU, Chongqing (CN); Wei JIA, Chongqing (CN); Muxing TAN, Chongqing (CN)

(21) Appl. No.: 19/081,102

(22) Filed: Mar. 17, 2025

(30) Foreign Application Priority Data
Mar. 18, 2024 (CN) 202410306015.4

(51) Int. Cl. B60N 2/90

(52) U.S. Cl. CPC B60N 2/914

(57) ABSTRACT

A cushion with adjustable softness and hardness and an automobile seat may have an air cushion body which has an inflation chamber in it. In the horizontal cross-section of the air cushion body, the inflation chamber is configured into a mesh-like shape. The beneficial effects of the device are: through the designed mesh-structured inflation chamber, when a certain area of the seat cushion surface is subjected to pressure, the mesh structure can distribute the force to the surrounding areas, creating a pulling effect to increase the elasticity of the cushion in an uninflated state, thus eliminating the need for an additional flexible material or cushioning material and helping to reduce the sinking sensation when the occupant is seated.

### FIELD

The device described herein relates to the technical field of automobile seats, specifically to a cushion with adjustable softness and hardness and an automobile seat.

### BACKGROUND

In recent years, as the usage of automobiles has increased, people have become more concerned about the comfort of automobile riding. To enhance the user's riding experience, the seat cushions of most automobiles are equipped with a function for adjusting softness and hardness.

The adjustment of the softness and hardness of automobile seat cushions mainly relies on air pouches integrated inside the automobile seat, where a pump inflates or deflates the air pouches to achieve the adjustment of the seat cushion's softness and hardness. For example, in the prior art, a Chinese invention patent with publication number CN111055738A discloses a softness and hardness adjustment device for automobile seats and an automobile seat, wherein the inflation and deflation of each air pouch are controlled by switching an air valve to achieve the adjustment of seat softness and hardness. However, since the air pouches are independent of each other, when inflated, the air pouches expand into a spindle shape instead of rising as a whole flat surface, which damages the seat surface's structural appearance and affects comfort and aesthetics. In addition, since force cannot be transmitted between the air pouches, when the product is not inflated, passengers sitting on the seat will have a sinking sensation.

### SUMMARY

In view of this, one of the objectives of the device is to provide a cushion with adjustable softness and hardness so as to solve the problem of poor comfort in existing adjustable cushions, allowing passengers to have more comfortable riding experiences.

To achieve the above objective, the technical solution is as follows:

A cushion with adjustable softness and hardness, comprising an air cushion body, characterised in that: an inflation chamber is provided inside the air cushion body, and in the horizontal cross-section of the air cushion body, the inflation chamber is configured into a mesh-like shape.

With the adoption of this structure, when a certain area of the cushion surface is subjected to pressure, the mesh structure distributes the force to the surrounding areas, creating a pulling effect so that the elasticity of the cushion in the initial state is increased, thus reducing the sinking sensation.

As a preferred embodiment: polygonal holes are distributed on the air cushion body, and any two adjacent polygonal holes are connected by support ribs, wherein the mesh-like shaped inflation chamber is formed inside the support ribs. With the above structure, the support ribs corresponding to the side portions of each polygonal hole enhance the stability of the inflation chamber structure.

As a preferred embodiment: the polygonal holes are regular triangles, squares, regular pentagons, or regular hexagons. With the adoption of this structure, the air cushion retains significant elasticity even in an uninflated state, reducing the sinking sensation and meeting the comfort requirements of the seat.

As a preferred embodiment: a recessed platform is provided at the bottom of the polygonal holes, and a ventilation hole is provided at the centre of the recessed platform. With the adoption of this structure, the cushion with adjustable softness and hardness is integrated with the ventilation function of the automobile seat.

As a preferred embodiment: a supporting surrounding frame is circumferentially arranged on the air cushion body, wherein the interior of the supporting surrounding frame is in communication with the inflation chamber, and an air hole is arranged on its exterior. With the adoption of this structure, the supporting surrounding frame enhances the stability of the air cushion body structure, while the air hole ensures that the air cushion body can be inflated and deflated, thereby achieving the adjustment of the seat cushion's softness and hardness.

As a preferred embodiment: the lower part of the air cushion body is open-ended and is fixedly attached with a bottom plate by welding, wherein through-holes are provided on the bottom plate corresponding to the ventilation holes. With the adoption of the above structure, the bottom plate provides support, integrating the recessed platforms at the bottom of the air cushion body into a whole, thereby reducing the sinking sensation.

A second objective is to provide an automobile seat.

An automobile seat, characterised in that: a cushion with adjustable softness and hardness according to any of claims is installed inside the seat frame. With the adoption of this structure, it is ensured that the automobile seat will have a softness and hardness adjustment function.

As a preferred embodiment: the seat frame comprises a soft foam for occupant seating and a hard foam arranged below the soft foam, wherein the cushion with adjustable softness and hardness is arranged between the soft foam and the hard foam. With the adoption of the above structure, the soft foam ensures the smoothness of the seat surface and enhances user comfort, while the hard foam provides structural support.

As a preferred embodiment: a ventilation device is connected below the hard foam. With the adoption of this structure, it is ensured that the automobile seat has both the function of softness and hardness adjustment as well as ventilation. Compared to the traditional design wherein the ventilation layer is placed between the soft foam and the hard foam, this structure is more compact and provides a more uniform ventilation effect.

As a preferred embodiment: a seat cover is provided on the surface of the soft foam. With the adoption of this structure, the automobile seat is protected to ensure its service life and maintain user comfort.

Compared with the prior art, the beneficial effects of the are:
1. The cushion with adjustable softness and hardness and the automobile seat provided by the present utility model utilize evenly distributed polygonal holes, and since the inflation chamber is formed by support ribs between any two adjacent polygonal holes, the overall structure of the air cushion does not change when inflated, minimizing changes in the Z-direction and ensuring the smoothness of the seat. By inflating and deflating the air cushion body, the adjustment of the seat cushion's softness and hardness is achieved.
2. When a certain area of the seat cushion surface is subjected to pressure, the honeycomb structure can distribute the force to the surrounding areas, creating a pulling effect to increase the elasticity of the cushion in the uninflated state, eliminating the need for an additional flexible material or cushioning material, and helping to reduce the sinking sensation when the occupant is seated.
3. A ventilation hole is provided at the centre of the recessed platform bottom, which can be integrated with the ventilation function of the automobile seat, helping to optimize the overall seat structure.

### DESCRIPTION OF THE DRAWINGS

FIG. 1 is an exploded schematic diagram of the cushion with adjustable softness and hardness;

FIG. 2 is a schematic diagram showing the three-dimensional structure of the cushion with adjustable softness and hardness;

FIG. 3 is a schematic diagram showing the structure of the cushion with adjustable softness and hardness (front view perspective);

FIG. 4 is a sectional view taken along I-I in FIG. 3;

FIG. 5 is a sectional view taken along II-II in FIG. 3;

FIG. 6 is a schematic diagram of the automobile seat structure.

### DETAILED DESCRIPTION

The following provides a further explanation with reference to the embodiments and drawings.

### Embodiment 1

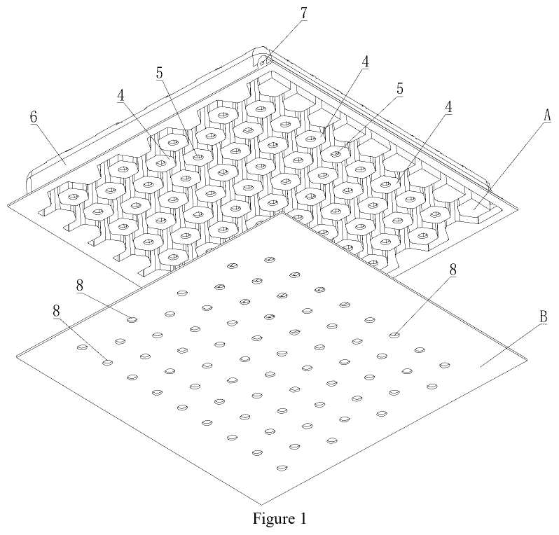

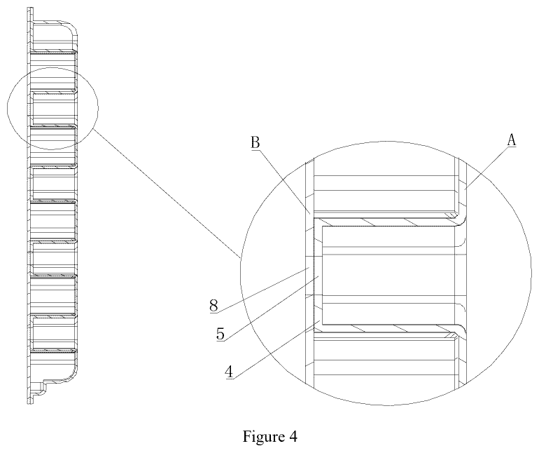

As shown in FIGS. 1 to 5, a cushion with adjustable softness and hardness comprises an air cushion body A, in which an inflation chamber 1 is provided. In the horizontal cross-section of the air cushion body A, the inflation chamber 1 is configured into a mesh structure. With this design, when a certain area of the cushion receives pressure, the mesh structure can distribute the force radially, improving the rebound elasticity of the cushion in an uninflated state and reducing the sinking sensation when occupant 12 sits on the cushion.

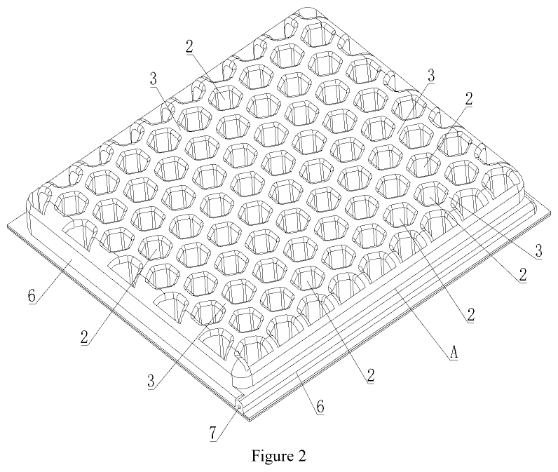

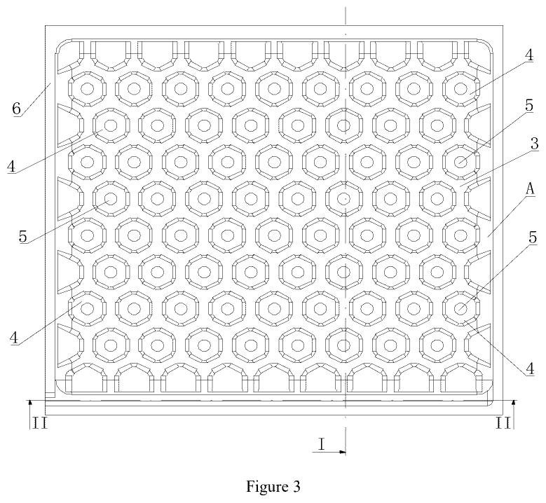

As shown in FIGS. 2 and 3, polygonal holes 2 are uniformly formed on the air cushion body A, and any two polygonal holes 2 are connected by support ribs 3. In this embodiment, the mesh-structured inflation chamber 1 is formed inside the support ribs 3.

Furthermore, the polygonal holes 2 may be regular polygonal structures such as equilateral triangles, squares, regular pentagons, or regular hexagons. In this embodiment, the cross-section of the polygonal holes 2 is preferably a regular hexagonal structure. The honeycomb structure thus formed distributes force more evenly, providing optimal seating comfort.

To enhance the overall structural robustness of the air cushion body A, a supporting surrounding frame 6 is circumferentially formed on the air cushion body A, wherein the interior of the supporting surrounding frame 6 is in communication with the inflation chamber 1, and an air hole 7 is provided on its exterior. The distal end of the air hole 7 is connected to an air pump, which enables the inflation and deflation of the air cushion body A, thereby adjusting the softness and hardness of the seat cushion.

Additionally, a bottom plate B is fixedly installed at the bottom of the air cushion body A. In this embodiment, the bottom plate B is welded to the air cushion body A for secure attachment. With this design, the bottom surfaces of the polygonal holes 2 form an integrated structure, helping to reduce the sinking sensation. To ensure the comfort of occupant 12 and prevent giving the sensation of ruggedness, the air cushion body A may be made of a soft silicone material, while the bottom plate B may be made of a PC material.

In this embodiment, a recessed platform 4 is provided at the bottom of each polygonal hole 2, with a ventilation hole 5 opened at the centre of the recessed platform 4, and the bottom plate B is provided with through-holes 8 corresponding to the ventilation holes 5. With this design, the cushion with adjustable softness and hardness can be organically integrated with the ventilation system of the automobile seat.

To optimize the structure and avoid affecting the integration of the air cushion body A with the automobile seat's ventilation function, in this embodiment, the ventilation hole 5 is isolated from the internal inflation chamber 1 of the air cushion body A, and the air hole 7 is arranged on the side of the air cushion body A.

With the above structure, this embodiment has at least two usage states:

### 1. Soft State

In this state, the air cushion body A is not inflated, and the internal air pressure of the air cushion body A is equal to the external air pressure. Since the air cushion body A is made of a flexible material and there are no support plates or limiting plates at the top of the air cushion body A, when occupant 12 sits down, there will be no ruggedness sensation. At the same time, due to the hexagonal honeycomb structure design on the surface of the air cushion body A, when occupant 12 sits down, the honeycomb structure can distribute the pressure radially, preventing the occupant 12 from experiencing a sinking sensation. There is no need for an additional flexible material or cushioning material to help reduce the sinking sensation when occupant 12 is seated.

### 2. Hard State

In this state, the air cushion body A is fully inflated. Due to the design of the hexagonal honeycomb structure and the fact that a closed air passage can be formed between the edges of each polygonal hole 2, the overall structure of the air cushion body A remains unchanged when fully inflated. The surface will not become a spindle shape, and the variation in the Z-direction is minimal, ensuring the smoothness and aesthetics of the seat cushion. At the same time, when occupant 12 sits on the cushion, there is no ruggedness sensation or discomfort.

### Embodiment 2

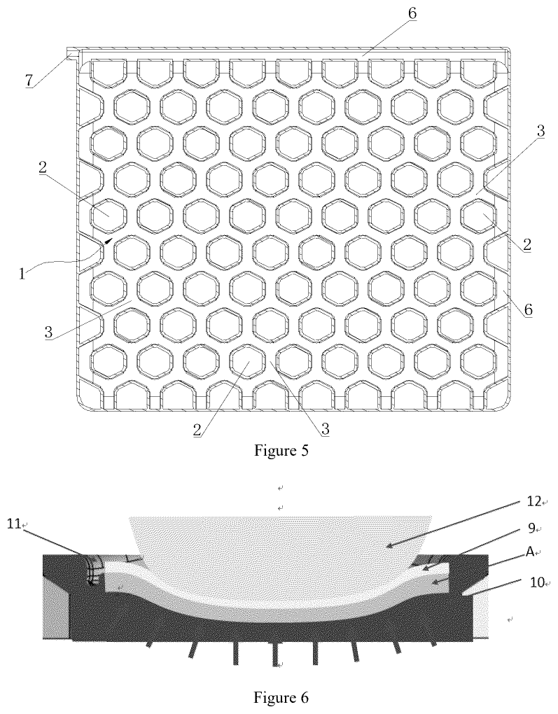

As shown in FIG. 6, an automobile seat comprises a soft foam 9 for occupant 12 seating and a hard foam 10 arranged below the soft foam 9, with an air cushion body A and a bottom plate B installed between the soft foam 9 and the hard foam 10. In this embodiment, the automobile seat ventilation system is arranged at the bottom of the hard foam 10. Compared with the traditional design wherein a ventilation layer is placed between the soft foam 9 and the hard foam 10, this embodiment optimizes the assembly structure of the automobile seat, making the installation of the ventilation system more convenient and improving its effectiveness.

To ensure the comfort, aesthetics, and service life of the automobile seat, in this embodiment, a seat cover 11 is used to cover the upper surface of the soft foam 9.

In this embodiment, since the cushion with adjustable softness and hardness is formed by welding an air cushion A and a bottom plate B into an integrated unit, the soft foam 9 and the hard foam 10 do not require additional grooves during foam moulding production. Only a groove matching the outer contour of the cushion with adjustable softness and hardness is needed to meet the production requirements of the soft foam 9 and hard foam 10.

Finally, it should be noted that only some preferred embodiments are described in the above. Those skilled in the art may make various similar modifications without departing from the spirit and scope of the device, and such modifications shall fall within the protection scope of the claimed device.

What is claimed is:

1. A cushion with adjustable softness and hardness, comprising an air cushion body (A), characterised in that: an inflation chamber (1) is provided inside the air cushion body (A), and in the horizontal cross-section of the air cushion body (A), the inflation chamber (1) is configured into a mesh-like shape.

2. The cushion with adjustable softness and hardness according to claim 1, characterised in that: polygonal holes (2) are distributed on the air cushion body (A), and any two adjacent polygonal holes (2) are connected by support ribs (3), wherein the mesh-like shaped inflation chamber (1) is formed inside the support ribs (3).

3. The cushion with adjustable softness and hardness according to claim 2, characterised in that: the polygonal holes (2) are regular triangles, squares, regular pentagons, or regular hexagons.

4. The cushion with adjustable softness and hardness according to claim 2, characterised in that: a recessed platform (4) is provided at the bottom of the polygonal hole (2), and a ventilation hole (5) is provided at the centre of the recessed platform (4).

5. The cushion with adjustable softness and hardness according to claim 1, characterised in that: a supporting surrounding frame (6) is circumferentially arranged on the air cushion body (A), the interior of the supporting surrounding frame (6) being in communication with the inflation chamber (1), and an air hole (7) being arranged on its exterior.

6. The hardness-adjustable cushion according to claim 1, characterised in that: the lower part of the air cushion body (A) is open-ended and is fixedly attached with a bottom plate (B) by welding, the bottom plate (B) being provided with through-holes (8) corresponding to individual ventilation holes (5).

7. An automobile seat, characterised in that: a cushion with adjustable softness and hardness according to claim 1 is installed inside a seat frame of the seat.

8. The automobile seat according to claim 7, characterised in that: the seat frame comprises a soft foam (9) for occupant seating and a hard foam (10) arranged below the soft foam (9), the cushion with adjustable softness and hardness being arranged between the soft foam (9) and the hard foam (10).

9. The automobile seat according to claim 8, characterised in that: a ventilation device is arranged below the hard foam (10).

10. The automobile seat according to claim 8, characterised in that: a seat cover (11) is provided on the surface of the soft foam (9).
